(19) United States
(12) Patent Application Publication
(10) Pub. No.: US 2010/0325224 A1
(43) Pub. Date: Dec. 23, 2010

(54) METHOD AND SYSTEM FOR MANAGING STORING OF MESSAGES IN COMMUNICATION NETWORK

(75) Inventors: Basavaraj Jayawant Pattan, Bangalore (IN); Mayuresh Madhukar Patil, Bangalore (IN); Seung-Yong Lee, Seoul (KR); Venkateswar Jeedigunta, Bangalore (IN)

Correspondence Address: THE FARRELL LAW FIRM, LLP, 290 Broadhollow Road, Suite 210E, Melville, NY, 11747, US

(73) Assignee: Samsung Electronics Co., Ltd.

(21) Appl. No.: 12/817,776

(22) Filed: Jun. 17, 2010

(30) Foreign Application Priority Data
Jun. 17, 2009 (IN) 1427/CHE/2009

(51) Int. Cl. G06F 15/16

(52) U.S. Cl. 709/206

(57) ABSTRACT

A method and system for storing of CPM messages in a communication network. The method includes receiving a CPM message that is to be delivered to a CPM client, identifying a user preference, sending the CPM message to the CPM client through a SIP channel, converting the CPM message into an IMAP, storing the IMAP message in the message storage server, receiving a UID associated with the IMAP message stored in the message storage server, and sending information associated with the CPM message and the UID to the CPM client.

### PRIORITY

This application claims priority under 35 U.S.C. §119(a) to an application filed in the Indian Patent Office on Jun. 17, 2009 and assigned Serial No. 1427/CHE/2009, the content of which is incorporated herein by reference.

### BACKGROUND OF THE INVENTION

1. Field of the Invention

The present invention, in general, relates to wireless communication technology, and more specifically, to managing the storage of messages in an Open Mobile Alliance (OMA) Converged Internet Protocol (IP) Messaging (CPM) architecture communication technology.

2. Description of the Related Art

In an existing OMA CPM architecture, CPM messages are delivered to a user in near real time via a Session Initiation Protocol (SIP) interface. Further, the CPM messages can also be sent to one or more recipients in one time.

For example, CPM messages include pager-mode messages, large-mode messages, session mode messages, file transfer mode messages, etc. An example of a pager-mode message is a simple text message, and an example of a large-mode message is a multimedia message, Accordingly, a CPM message may include several discrete media types, e.g., a text message, images, audio-clips, video-clips, etc.

In CPM architecture, a user can set various preferences before receiving a CPM message. These preferences will be checked by a CPM Participating Function (PF) in a server, and thereafter, the CPM PF will send the CPM message based on the preferences set by the user. For example, the user can set a conversation recording option in the CPM architecture to ‘ON’ while receiving a CPM message. Therefore, when a CPM message is delivered to the user, the CPM message/conversation is recorded in a storage area associated with the server, for example, a message storage server, while being simultaneously being sent to the user in real time via the SIP interface. The CPM message is stored in the storage of the server using an Internet Message Access Protocol (IMAP) interface. Currently, there is no connection between the CPM messages received via the SIP interface and the IMAP interface.

For example, when a pager-mode message is to be delivered to the user, the message will first arrive at the CPM PF. The CPM PF, depending on user preferences, delivers the pager-mode message to the user device via an SIP message over an interface, for example, the CPM-PF 1 interface in the CPM architecture. The CPM-PF 1 interface is made available by the CPM PF to enable other functional components (such as a CPM Client) to access/trigger functionalities of the CPM PF. The protocols used for the CPM-PF1 interface include an SIP, a Session Description Protocol (SDP), a Message Session Relay Protocol (MSRP), and a Real Time Protocol (RTP)/RTP Control Protocol (RTCP).

Thereafter, if the conversation storage option is set to “ON” then the same pager-mode message is stored on the message storage server via an IMAP protocol over a CPM interface, for example, a CPM-MSG interface. The pager-mode messages that are stored in the message storage server are later delivered to the message storage client via an IMAP protocol over a CPM interface, for example, a CPM-MSG interface. The CPM-MSG interface is made available by the message storage server to enable other functional components (such as the message storage client, the CPM PF, or a remote environment trusted server) to access the message storage server. The protocol used for the CPM-MSG interface is an Internet Message Access Protocol 4 (IMAP4)

Consequently, the message is delivered to the user device twice; once using an SIP message over the CPM-PF1, and again by the pager-mode messages that are stored in the message storage server, which are delivered to the message storage client via an IMAP protocol over a CPM-MSG interface.

Similarly, for a large-mode message, for example, a session mode message and file transfer, the large-mode message is delivered to the CPM user device via an SIP MSRP over the interface CPM-PF 1. However, if the conversation recording option is set to “ON”, the large-mode message also gets delivered to the CPM device using the IMAP protocol. Thus, the message gets stored twice.

Accordingly, the conventional method is not efficient as it delivers the same CPM messages twice to the CPM user device.

### SUMMARY OF THE INVENTION

The present invention is designed to address at least the above-mentioned problems and/or disadvantages and to provide at least the advantages described below. Accordingly, an aspect of the present invention is to provide a system and method for managing the storage of CPM messages in a communication network.

In accordance with an aspect of the present invention, a method for managing storage of CPM messages in a communication network is provided. The method includes receiving a CPM message that is to be delivered to a CPM client, identifying user preferences preset by the CPM client, sending the CPM message to the CPM client through a SIP channel, converting the CPM message into an IMAP message, when the user preference associated with the storing of the CPM message is enabled, storing the IMAP message in the message storage server, when the user preference associated with storing of the CPM message is enabled, machining a Unique ID (UID) associated with the IMAP message stored in the message storage server, and sending information associated with the CPM message and the UID associated with the IMAP message to the CPM client.

In accordance with another aspect of the present invention, a method for managing storage of CPM messages in a communication network is provided. The method includes receiving a CPM message that is to be delivered to a CPM client, identifying user preferences preset by the CPM client, converting the CPM message into an IMAP message, when the user preference associated with the storing of the CPM message is enabled, matching a UID associated with the IMAP message stored in the message storage server, and sending information associated with the CPM message and the UID associated with the IMAP message to the CPM client.

In accordance with another aspect of the present invention, a method for managing storing of CPM messages in a communication network is provided. The method includes receiving a CPM message that is to be delivered to a CPM client, sending the CPM message to the CPM client using a SIP channel, converting the CPM message to an IMAP message based on the Contribution ID, Conversation ID, and In-reply ID, when a user preference for storing the CPM is enabled, sending the IMAP to the message storage server for storing the IMAP message, and matching a UID from the message storage server, when the CPM message is stored in the message storage server.

In accordance with another aspect of the present invention, a server communication entity is provided. The server communication entity includes a processor and a transceiver. The transceiver receives a CPM message that is to be delivered to a CPM client, sends the CPM message to the CPM client through a SIP channel, matches a UID associated with an IMAP message stored in a message storage server, and sends information associated with the CPM message and UID associated with the IMAP message to the CPM client. The processor identifies user preferences set by the CPM client, converts the CPM message into the IMAP message, when the user preference associated with the storing of the CPM message is enabled, and stores the IMAP message in the message storage server, when the user preference associated with storing of the CPM message is enabled.

In accordance with another aspect of the present invention, a client communication entity is provided. The client communication entity includes a processor and a transceiver. The transceiver receives, from a CPM PF, a CPM message and CPM message information associated with the CPM message. The CPM message information includes at least one of a UID, conversation ID, contribution ID and an In-reply-to ID. The processor converts the CPM message into an IMAP message, when the user preference associated with the storing of the CPM message is enabled, stores the IMAP message in a message storage client, when a user preference associated with storing of the CPM message is enabled, associates the CPM message information with the stored IMAP message, and synchronizes the stored messages in the message storage server and a message storage client.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a flow diagram illustrating a conventional method for storing CPM messages;

FIG. 2 is a flow diagram illustrating a method for managing the storage of CPM messages, in accordance with an embodiment of the present invention;

FIG. 3A, FIG. 3B, and FIG. 3C are flow diagrams illustrating a method for managing the storage of CPM messages, in accordance with an embodiment of the present invention;

FIG. 4 is a flow diagram illustrating a method for managing the storage of CPM messages, in accordance with an embodiment of the present invention;

FIG. 5 illustrates a server communication entity, in accordance with an embodiment of the present invention; and

FIG. 6 illustrates a client communication device entity, in accordance with an embodiment of the present invention.

Throughout the drawings, it should be noted that like reference numbers are used to depict the same or similar elements, features, and structures.

### DETAILED DESCRIPTION OF EMBODIMENTS OF THE INVENTION

The following description, with reference to the accompanying drawings, is provided to assist in a comprehensive understanding of certain embodiments of the present invention as will be defined by the claims and their equivalents. Although the description includes various specific details to assist in that understanding, these are to be regarded as merely exemplary. Accordingly, those of ordinary skill in the art will recognize that various changes and modifications of the embodiments described herein can be made without departing from the scope and spirit of the present invention. In addition, descriptions of well-known functions and constructions are omitted for clarity and conciseness.

The terms and words used in the following description and claims are not limited to the dictionary meanings, but are merely used by the inventor to enable a clear and consistent understanding of the present invention.

It is to be understood that the singular forms “a,” “an,” and “the” include plural referents unless the context clearly dictates otherwise. Thus, for example, reference to “a component surface” includes reference to one or more of such surfaces.

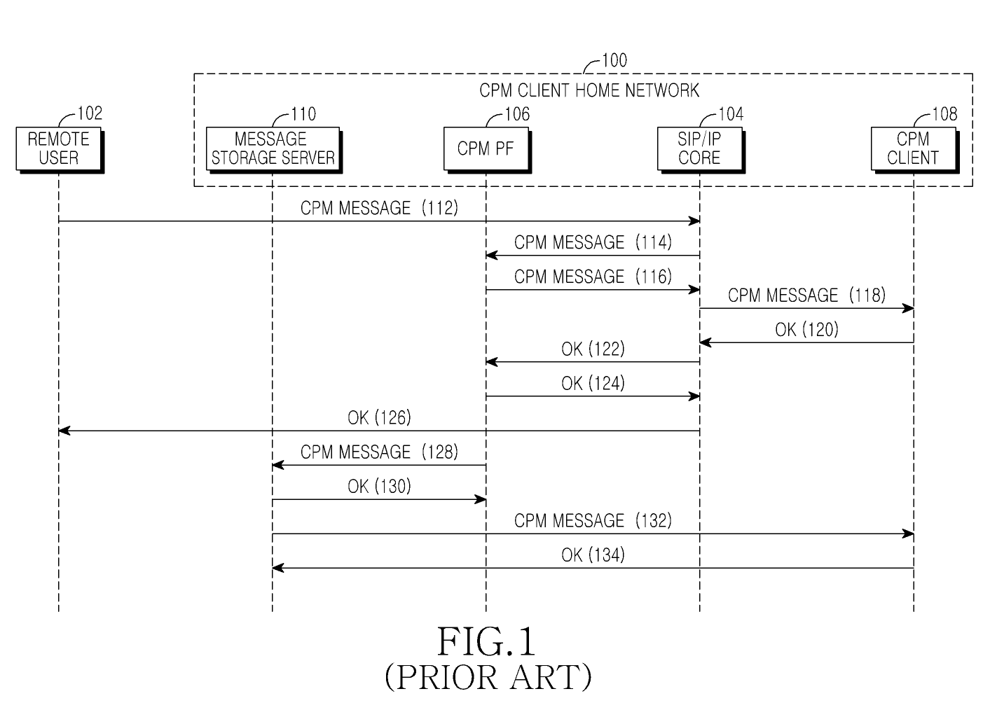

FIG. 1 is a flow diagram illustrating a conventional method for storing CPM messages.

Referring to FIG. 1, a remote user 102 communicates with a CPM client home network 100. The remote user 102 can be in a remote network or in the same network. The CPM Client Home Network 100 includes an SIP/IP core 104, a CPM Participating Function (PF) 106, a CPM client 108, and a Message Storage Server 110. Though only four entities are illustrated in FIG. 1, by way of example, the network may also include more or less entities.

When the remote user 102 wants to send a CPM message to the CPM client 108, the CPM message is passed through the SIP/IP core 104 and the CPM PF 106. Examples of a CPM message include a pager-mode message, a large-mode message, a session based message, and a file transfer message.

More specifically, at step 112, in order to send a CPM message to the CPM client 108, the remote user 102 sends the CPM message to the SIP/IP core 104. At step 114, the CPM message is sent to the CPM PF 106, which checks user preferences to take further actions. An example of a user preference includes a preference for storing CPM messages in the server (e.g., conversation recording).

At step 116, the CPM message is sent to the SIP/IP core 104 so that the SIP/IP core 104 can send the CPM message further to other entities, for example, the CPM client 108.

At step 118, the CPM message is forwarded to the CPM client 108. At step 120, the CPM client sends an OK message to the SIP/IP core 104, after successfully receiving the CPM message. At steps 122 and the OK message is exchanged between the CPM PF 106 and the SIP/IP core 104. The CPM message, for example, a pager-mode message, is delivered to the CPM client 108 using an SIP message over an interface CPM-PF-1.

At step 126, an OK message is sent to the remote user 102 by the SIP/IP core 104.

At step 128, the CPM PF sends the CPM message to the message storage server 110, assuming that the user preference for storing the CPM message is enabled (e.g., the conversation recording preference is ON). The CPM message, is stored on the message storage server 110 via an IMAP over an interface CPM-MSG.

At step 130, the message storage server 110 sends the OK message to the CPM PF, after storing the CPM message in the message storage server 110. Thereafter, at step 132, the CPM message is sent to the CPM client 108 from the message storage server 110 via IMAP protocol over the interface CPM-MSG.

At step 134, the CPM client 108 sends an OK message to the message storage server 110, after successfully storing the CPM message received from the message storage server 110.

For example, when a large-mode message is delivered to the CPM client 108 via an SIP MSRP over the interface CPM-PF 1, the CPM device 108 receives the same CPM Messages twice. Thus, the conventional method delivers the same CPM message twice to the CPM client; once during conversation, and once from the message storage server.

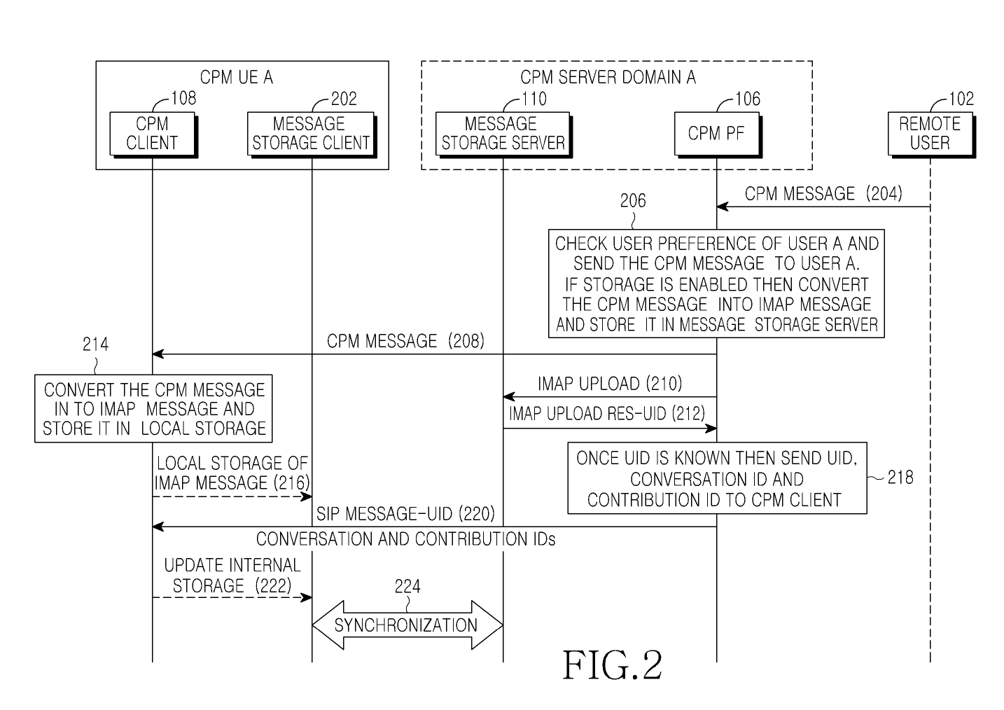

FIG. 2 is a flow diagram illustrating a method for managing the storage of CPM messages, in accordance with an embodiment of the present invention.

Referring to FIG. 2, at step 204, the remote user 102 sends a CPM message to a CPM PF 106. At step 206, the CPM PF 106 checks user delivery preferences before delivering the CPM message to CPM client 108. Further, the CPM PF 106 also checks if the CPM message should be stored in a message storage server, for example, in the message storage server 110, based on the set user preferences.

At step 208, the CPM message is delivered to the CPM client 108 over the CPM-PF1 interface. At step 210, the CPM message is converted to an IMAP message and stored in the message storage server 110, if storage is enabled. At step 212, a UID is received by the CPM PF 106. The UID is associated with the CPM message that is converted to the IMAP message and is stored in the message storage server 110.

At step 214, the CPM client 108 converts the CPM message to an IMAP format, and at step 216, the CPM client 108 stores the IMAP message locally in a local storage, for example, in a message storage client 202. Thereafter, the message storage client 202 and the message storage server 110 synchronize the stored CPM message.

At step 218, when the UID is known to the CPM PF 106, the UID, a conversation ID, and a contribution ID are sent to the CPM client 108 at step 220. At step 222, the CPM client 108 updates the UID, the conversation ID, and the contribution ID with the stored CPM message in the message storage client 202. Accordingly, when the locally stored messages in the message storage client 202 are synchronized with the message storage server 110, the user of the CPM client 108 will be able to identify the corresponding message on the message storage server 110, without explicitly fetching the message from the message storage server 110.

At step 224, the message storage server 110 and the message storage client 202 are synchronized to prevent any mismatching of messages in the storage of CPM messages.

While performing synchronization, the message storage client 202 selectively ignores the fetching of messages from the message storage server 110 for the UID that is received in the message via PF-1 interface, thereby avoiding duplicate message retrieval. The CPM client 108 then retains the UID information along with the CPM message on the message storage client 202. Consequently, there is no duplicate delivery of a CPM message to the CPM client 108.

In accordance with an embodiment of the present invention, the CPM message may be delivered to multiple clients, e.g., depending on user preferences, via the CPM-PF1 interface. When the CPM message may be delivered to multiple clients, the method will temporarily store contact IDentities (IDs) of each of the multiple clients and will send the CPM message including the UID information. However, if the user preference is set to store the CPM message in the message storage server, then the CPM PF 106 converts the CPM message to an IMAP format and uploads it to the message storage server 110 using IMAP protocol over a CPM-MSG interface. Thereafter, the UID information is sent to the multiple clients.

The above-described method will be further described below with reference to a particular example. The example, however, is solely for the purpose of more clearly describing the method and in no way is intended to limit the scope of the present invention to the specific example.

In the example, a message is received by a server along with meta-data information. The preference for storing conversation in the server is enabled. Additionally, the example described below uses different message formats and different functions to perform the method. Accordingly, for the purpose of this example, different formats and functions are initially explained below.

A CPM message is identified as a UID information message by examining its content. The CPM message is a UID information message, if the content-type header field present in a received message has a value of “message/imap-uid+xml”, and the <imap-uid-info> element appears in an Extensible Markup Language (XML) body.

An IMAP UID information payload is an XML document [XML] that is well formed and should be valid according to schemas, available to validate and be applicable to the XML document. The UID information payload is based on XML 1.0 and is encoded using Universal Character Set Transformation Format (UTF-8).

The name space identifier for elements defined by the disclosure is a Uniform Resource Name (URN). For example, the name space declaration urn:oma:params:xml:ns:imap-uid indicates name space on which the UID information is based. The root element is <imap-uid-info>. The <imap-uid-info> element has sub-elements, namely <imap-uid>, <conversation-id>, <contribution-id>, and <reply-to-contribution-id>.

The <imap-uid> element is mandatory according to XML schema and carries an ID that appeared in the message attribute UID of an IMAP message response.

The <conversation-id> element is mandatory according to the XML schema and carries the UID of a CPM conversation of the message previously delivered to the CPM client.

The <contribution-id> element is mandatory according to the XML schema and carries the unique identification of the CPM message or of the CPM session belonging to a CPM Conversation.

The <reply-to-contribution-id> element is optional according to the XML schema and carries the contribution identity of the CPM message.

The Multipurpose Internet Mail Extensions (MIME) type for the IMAP UID information message payload is “message/imap-uid+xml”. The IMAP UID Information message should identify a payload as a MIME type “message/imap-uid+xml” in the content-type header field.

In the example, the message is received and processed as follows:

C: A003 APPEND INBOX {297}
C: Date: Mon, 7 Feb 1994 21:52:25 -0800(PST)
C: From: Fred Foobar <foobar@example.com>
C: Subject: afternoon meeting
C: To: mooch@example.com
C: Message-Id: <B27397-0100000@example.com>
C: MIME-Version: 1.0
C: Content-Type: TEXT/PLAIN;CHARSET=US-ASCII
C: Hello Joe, do you think we can meet at 3:30 tomorrow?

The message is then uploaded in the message storage server 110, and the CPM PF 106 receives UID information for the just uploaded CPM message from the message storage server 110 as shown below.

S: A003 OK [APPENDUID 38505 3955] APPEND completed

The CPM PF 106 constructs a new SIP message with the content-type “message/imap-uid+xml”, which includes the UID information in a body of the SIP message and other information associated with the message. The other information includes conversation-Id, contribution-Id, In-reply-to Id, etc. The newly constructed SIP message is sent to the CPM client 108. Additionally, the message may be forked to multiple devices in a multiple device scenario.

After receiving the SIP message, the CPM client 108 then updates the locally stored message with the UID information. The locally stored message is identified based on the conversation-id, contribution-id, In-reply-to contribution id, and other information associated with the message.

To: Mooch <sip:mooch@example.com>
NS: imap-uid-info <urn:oma:params:xml:ns:imap-uid>
Content-type: message/imap-uid+xml
Content-length: ...
</xml version=“1.0” encoding=“UTF-8”?>
<imap-uid-info xmlns=“urn:oma:params:xml:ns:imap-uid”>
<conversation-id>34jk324j</conversation-id>
<contribution-id>13k324j1</contribution-id>
<reply-to-contribution-id>234324j2</ reply-to-contribution-id>
<imap-uid>3955</imap-uid>
</imap-uid-info>

In accordance with an embodiment of the invention, the original CPM message includes the UID information associated with the CPM message. In accordance with another embodiment of the invention, to attach the UID information to the CPM message, the CPM PF 106 will wait until it receives the UID information of the stored CPM message from the message storage server 110 before delivering the CPM message to the CPM client 108.

Further, in order to synchronize the locally stored messages in the message storage client 202 with the stored messages in a CPM User's network-based message storage, for example, the message storage server 110, the message storage client 202 acts according to the procedures of RFC5162 “IMAP4 Extensions for Quick Mailbox Resynchronization” for deactivated (suppressed) automatic synchronization.

Thus, while performing synchronization, the message storage client 202 selectively ignores the fetching of a message from the message storage server 110 for the UID that is received in the message via CPM-PF-1 interface, thereby avoiding duplicate message retrieval. The CPM client 108 then retains the UID information along with the CPM message on the message storage client 202. Accordingly, no duplicate delivery of a CPM message to the CPM client 108 is performed.

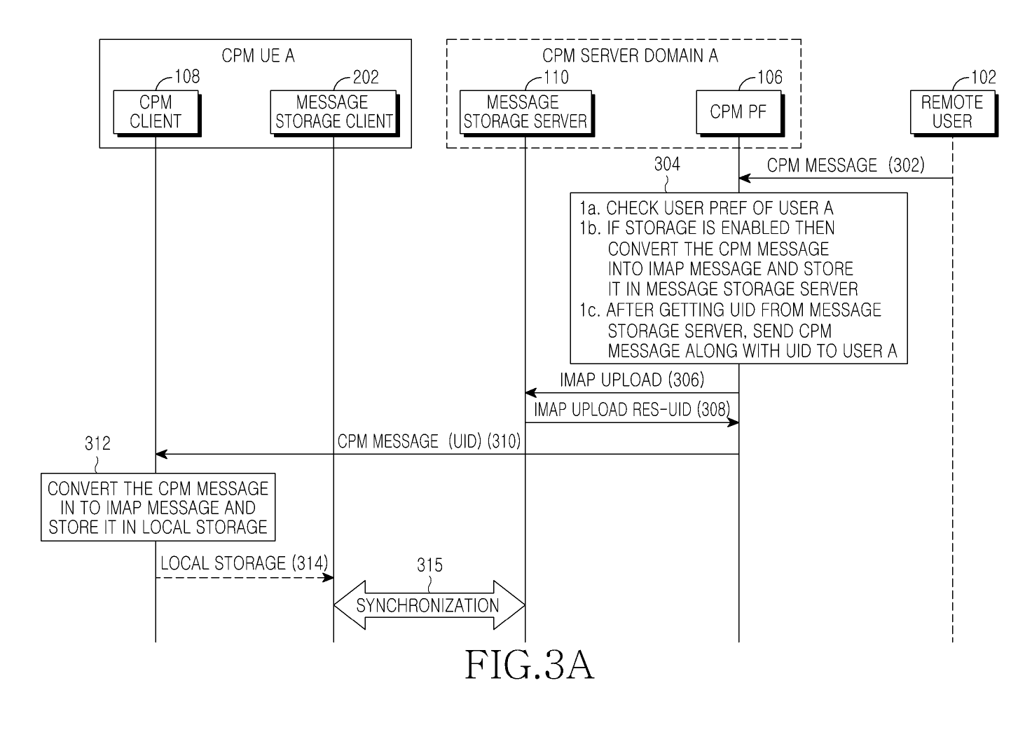

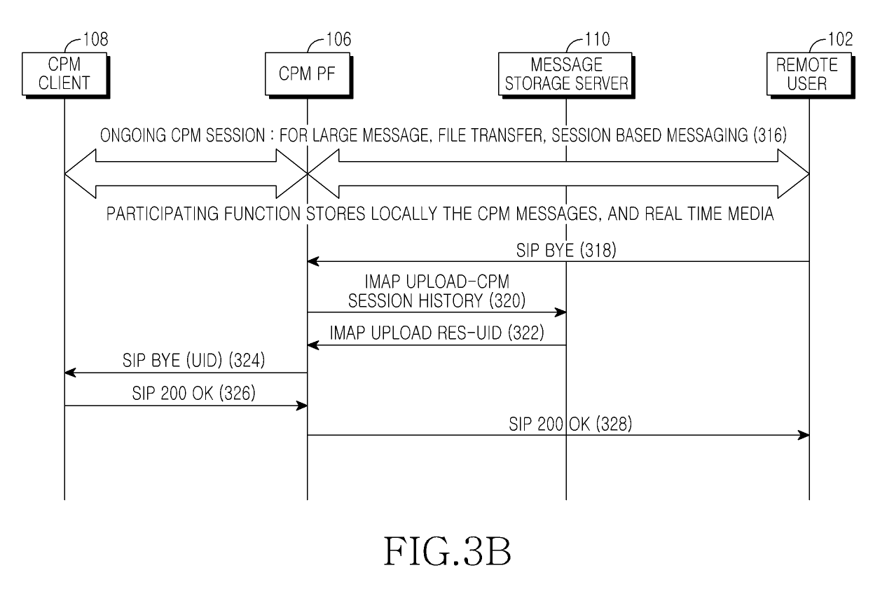

FIGS. 3A to 3C are a flow diagram illustrating a method for managing the storage of CPM messages, in accordance with an embodiment of the present invention.

Referring to FIG. 3A, at step 302, the remote user 102 sends a CPM message to a CPM PF 106. At step 304, the CPM PF 106 checks user delivery preferences before delivering the CPM message to the CPM client 108. Further, the CPM PF 106 checks if the CPM message should be stored in the message storage server 110, based on the set user preferences. Thus, if the conversation storage option is enabled, the CPM message is converted to an IMAP message and stored in the message storage server 110. Thereafter, the method waits to receive a UID associated with the stored CPM message from the message storage server 110. At step 306, the CPM message that is converted to the IMAP message is uploaded in the message storage server 110.

At step 308, a UID associated with the IMAP upload is received by the CPM PF 106. At step 310, the CPM message and the UID associated with the CPM message are delivered to the CPM client 108, over the CPM-PF1 interface. At step 312, the CPM client 108 converts the CPM message to an IMAP format and stores the IMAP format message locally in the message storage client 202, at step 314. Thereafter, at step 315, the message storage client 202 and the message storage server 110 synchronize the stored CPM message. Alternatively, The UID associated with the IMAP upload can be generated by the CPM PF 106.

While performing synchronization, the message storage client 202 selectively ignores fetching of a message from the message storage server 110 for the UID that is received in the message via PF-1 interface, thereby avoiding duplicate message retrieval. The CPM client 108 retains the UID information along with the CPM message on the message storage client 202, which prevents a duplicate delivery of a CPM message to the CPM client 108.

In the above-described method, when the CPM message is being recorded on the message storage server 110, the CPM PF 106 will retrieve the IMAP UID information and forward that information to the CPM client 108 to keep the device locally stored CPM messages up to date and complete information.

When a CPM message arrives at the CPM PF 106 to be delivered to a user of the CPM client 108, the CPM PF 106 checks the user delivery preferences before delivering to the CPM client. The CPM PF 106 checks if the CPM message should be stored in the message storage server 110 based on the set user preferences. The CPM message is not delivered to the CPM client 108 until it receives UID information associated with the CPM message from the message storage server 110.

However, if the user preference is set to store the CPM message in the message storage server 110, then the CPM PF 106 converts the CPM message to an IMAP format and uploads it to the message storage server 110 using an IMAP protocol over a CPM-MSG interface. The CPM PF 106 receives the UID information for the just uploaded CPM message from the message storage server 110. The received UID information is then included in the CPM message before delivering to the CPM client 108 over the CPM-PF1 interface. The UID is included in the CPM message. The CPM-PF1 interface supports an SIP protocol, and the UID can be included in any of the request or response during an SIP session. Examples of SIP functions include an SIP INVITE, an SIP BYE or an SIP response (e.g., SIP 200 OK).

A new SIP header “Message-UID” is defined to include the UID information in the SIP message request, 200 OK SIP response, or SIP BYE request. When a CPM message, CPM file transfer history, or CPM session history is stored by the CPM PF 106 in the message storage server 110, the CPM PF 106 includes a Message-UID header in an SIP MESSAGE request, 200 OK SIP response, or SIP BYE request or other SIP methods, associated with the CPM message, the CPM file transfer history, or the CPM session history. Further, when the CPM message includes this header, the CPM client stores the value of this Message-UID header with the received CPM Message, CPM File Transfer History, or CPM Session History in the message storage client 202.

When synchronizing the CPM messages on the locally stored in a client, for example, the message storage client 202, with the message storage server 110, the CPM message having this value will not be retrieved again. An example of this SIP header is Message-UID: 3737. In accordance with an embodiment of the present invention, the CPM message is a pager-mode message. Thus, if the CPM message is recorded successfully, then CPM PF 106 should include the UID information associated with the CPM message in a message-UID SIP header in the SIP message, and send the CPM message to the CPM client 108. However, if message is not delivered to the CPM client 108, the CPM PF 106 should delete the stored message from the message storage server 110 using the UID information.

Further, if the CPM client 108 receives the pager-mode message and a Message-UID header is included in the CPM message, the CPM client 108 should store the UID value with the CPM message in the local storage (e.g., message storage client 202) of the CPM client 108.

In FIG. 3B, a method for storing CPM message is illustrated for a scenario in which a remote user disconnects from communication with a CPM client using an SIP BYE request after a CPM session.

Referring to FIG. 3B, at step 316, a CPM communication session between the remote user 102 and the CPM client 108 via a CPM PF 106 occurs. The CPM PF 106 stores locally the CPM messages and real time media. The CPM messages and the real time media are stored in the message storage server 110.

At step 318, the remote user 102 sends a SIP BYE request, and at step 320, the CPM PF 106 stores the session or large mode message in the message storage server 110. The CPM PF 106 converts the CPM message to an IMAP and uploads the CPM session history in the message storage server 110. At step 322, the message storage server 110 sends a UID associated with the recently stored IMAP message. At step 324, the CPM PF 106 sends a SIP BYE request including the UID information in the Message-UID SIP header in the SIP BYE request to the CPM client 108.

At step 326, the CPM client 108 sends the SIP 200 OK function to the CPM PF 106, after uploading and associating the CPM message information with the locally stored IMAP message. Examples of CPM message information include a UID associated with the CPM message, a conversation ID, and a contribution ID associated with the CPM message. At step 328, the CPM PF 106 sends the 200 OK message to the remote user 102.

In FIG. 3C, a method for storing CPM message is illustrated for a scenario in which a CPM client disconnects communication with a remote user using a SIP BYE function, after establishing a CPM session with remote user.

Referring to FIG. 3C, at step 330, an ongoing CPM communication session between the remote user 102 and the CPM client 108 via a CPM PF 106 occurs. The CPM PF 106 stores locally the CPM messages and real time media. The CPM messages and the real time media are stored in the message storage server 110.

At step 332, the CPM client 108 sends a SIP BYE request to the CPM PF 106, and the CPM PF 106 stores the CPM session or large mode message in the message storage server 110. At step 334, the CPM PF sends a SIP BYE request to the remote user 102. At step 336, the remote user 102 sends a 200 OK response to the CPM PF 106.

At step 338, the CPM PF 106 uploads the CPM session history messages in an IMAP format in the message storage server 110. At step 340, the message storage server 110 sends a UID associated with the uploaded message to the CPM PF 106. At step 342, the CPM PF 106 sends the SIP 200 OK response and the UID associated with the uploaded message to the CPM client 108.

Thereafter, the CPM messages are synchronized between the message storage server 110 and a local storage of the CPM client 108.

In accordance with an embodiment of the present invention, if the CPM message(s) are not delivered to the CPM client 108, the PF 106 deletes the stored message or session from the message storage server 110 using the UID information. Further, if the CPM client 108 receives the message UID in a SIP BYE request or in a 200 OK response, the CPM client 108 should store the UID value with the CPM message or CPM session in the local storage of the CPM client 108.

In accordance with an embodiment of the present invention, the UID information is included in the CPM message along with a conversation-ID, a contribution-ID, etc. The CPM client 108 converts the message to an IMAP format in order to store it locally. Accordingly, the message that is being stored in the message storage server 110 and the device local storage will be in the IMAP format. The locally stored CPM message in the IMAP format will also includes the associated UID information.

In order to synchronize the locally stored messages with the messages stored in the message storage server 110, the local storage entity acts according to procedures of RFC5162 “IMAP4 Extensions for Quick Mailbox Resynchronization” for the case of deactivated (suppressed) automatic synchronization. However, while doing synchronization, the local storage entity selectively ignores fetching the message from message storage server 110 for the UID that is received in the message via PF-1 interface. Accordingly, when the locally stored messages are synchronized with the message stored in the message storage server 110, the user will be able to identify the corresponding message on the network that is in message storage server 110.

In accordance with an embodiment of the present invention, the CPM message stores identities in IMAP message IDs. For example, the CPM message identifiers are stored into the IMAP message identifiers and those identifiers are returned in the descriptors to the CPM client 108. The CPM client 108 can then compare if a CPM message already exists on the device with the identifiers. Accordingly, if the identifiers already exist, then the CPM client 108 will attach a UID to that CPM message.

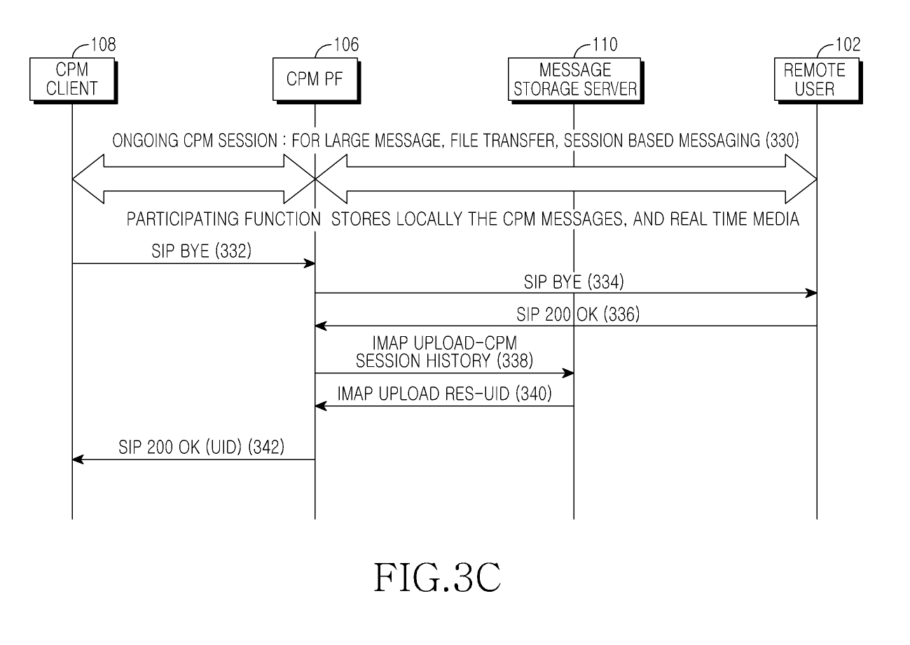

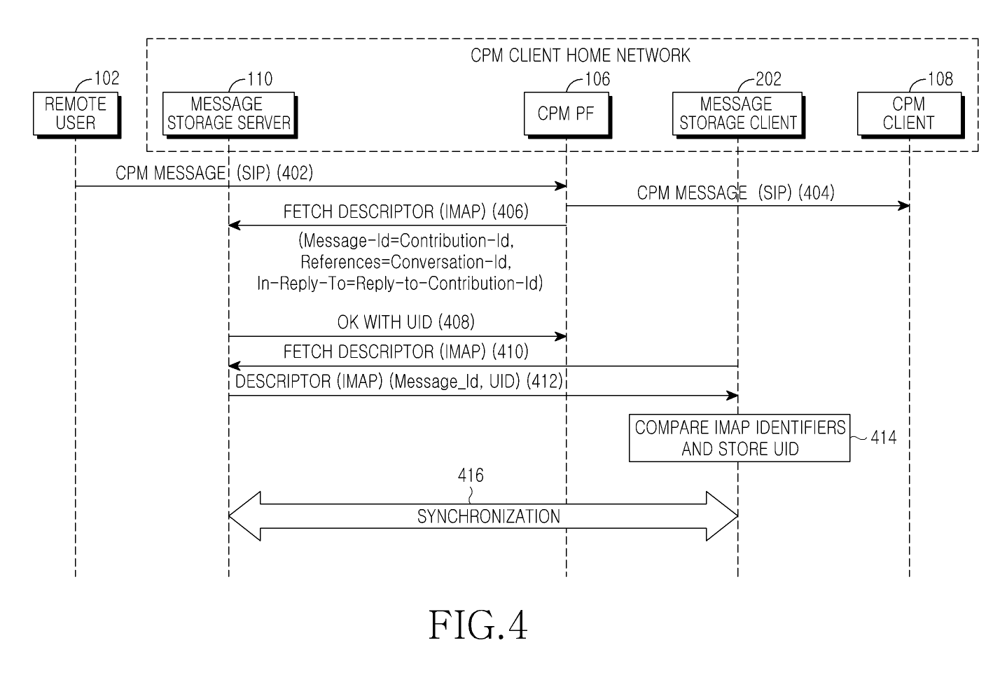

FIG. 4 is a flow diagram illustrating a method for managing the storage of CPM messages, in accordance with an embodiment of the present invention.

Referring to FIG. 4, at step 402, the CPM PF 106 receives a CPM message from the remote user 102 using a SIP session. At step 404, the CPM message is transferred to the CPM client 108 using a SIP session. At step 406, the CPM PF 106 fetches a descriptor from the message storage server 110 based on a contribution ID, a conversation ID, and an In-reply-to ID through an IMAP message.

In accordance with an embodiment of the present invention, the message ID is associated with the contribution ID, references are associated with the conversation ID, and the In-reply-to ID is associated with a reply-to-contribution ID.

In accordance with an embodiment of the present invention, the CPM message is converted to the IMAP message, based on the contribution ID, the conversation ID and the In-reply-to ID.

At step 408, the UID is received by the CPM PF 106.

At step 410, the message storage client 202 fetches the message descriptor from the message storage server 110 using an IMAP message format. At step 412, the message storage server replies with descriptors that include a message ID, a UID, and other information. At step 414, the message storage client 202 compares the IMAP message and stores the UID. At step 416, the message storage server 110 and the message storage client 202 perform synchronization.

When a CPM message arrives at a terminating domain to be delivered to the CPM client 108, the CPM PF 106 checks user delivery preferences before delivering to CPM client.

As an example, the received CPM Message has the following identifiers attached to it.

conversation-id = 34jk324j
contribution-id = 13k324j1
reply-to-contribution-id = 234324j2

The CPM PF 106 checks if the CPM message should be stored in the message storage server 110 based on the set user preferences. If the user preference is set to store the CPM message in the message storage server 110, the CPM PF 106 converts the CPM message to an IMAP format and uploads it to the message storage server 110 using an IMAP protocol over a CPM-MSG interface. While converting CPM message to IMAP format, the CPM PF 106 will map the following CPM Message identifiers to IMAP message headers:

IMAP Message-Id = Contribution-Id from CPM Message
IMAP References = Conversation-Id from CPM Message
IMAP Reply-To = Reply-to-Contribution-Id from CPM Message
Example: IMAP headers will be mapped to CPM Message identifiers
References: <34jk324j>> //conversation-id
Message-ID: <13k324j1>> //contribution-id
In-Reply-To: <234324j2>> //reply-to-contribution-I

Thereafter, the CPM PF 106 receives UID information for the uploaded CPM message from the message storage server 110. The CPM client 108 then requests an IMAP server for the descriptors of UIDs.

In accordance with an embodiment of the present invention, the CPM client 108 can use a search command with the message identifiers to receive the UID information in response. In accordance with another embodiment of the present invention, the IMAP sever can initiate a notification including the UID information and the descriptors, such as a contribution-ID, a conversation-ID, etc.

In accordance with an embodiment of the present invention, the descriptors may also include all the IMAP message identifiers and the UID information. The CPM client 108 will then compare if it has a message in the message storage client 202 with the same message identifiers. If the CPM client 108 identifies a message with the same message identifiers, it will attach UID information to that message and indicate to user that the particular message is already available on the message storage client 202.

As an example, the received descriptors include:

References: <34jk324j>> //conversation-id
Message-ID: <13k324j1>> //contribution-id
In-Reply-To: <234324j2>> //reply-to-contribution-id
UID: 3955

However, in order to synchronize the message storage client 202 with the stored items in the message storage server 110, the message storage client 202 acts according to the procedures of RFC5162 “IMAP4 Extensions for Quick Mailbox Resynchronization” for the case of deactivated (suppressed) automatic synchronization.

While performing synchronization, the message storage client 202 selectively ignores fetching the message from the message storage server 110 for the UID that is received in the message via PF-1 interface. This prevents the message storage client 202 from retrieving the message again from the message storage server 110.

In accordance with an embodiment of the present invention, a Status Flag synchronization method may also performed. Status Flags include a list of zero or more named tokens associated with the message. Examples of Status Flags include \Seen, \Answered, \Flagged, \Deleted, \Draft, \Recent, etc. For a CPM Message received over the CPM-PF1 interface with the UID information, the status flags also should be synchronized from the CPM client 108 to a corresponding CPM message in message storage server 110. The status flags can be updated to the corresponding CPM message on the message storage server 110 using an IMAP protocol.

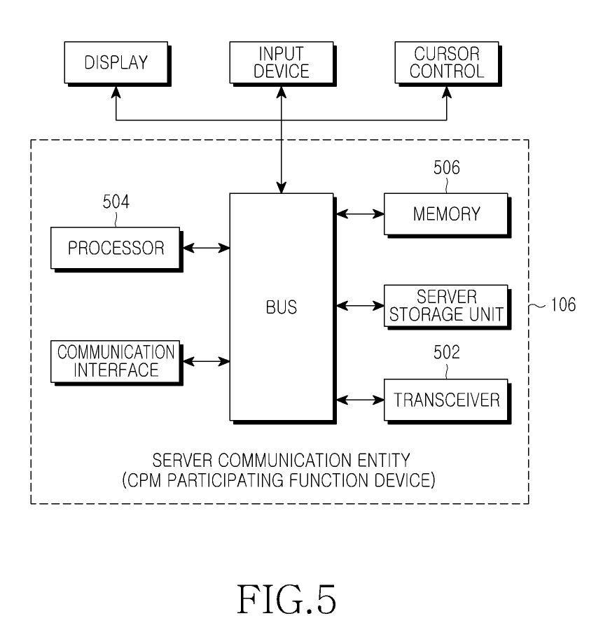

FIG. 5 illustrates a server communication entity, in accordance with an embodiment of the present invention.

Referring to FIG. 5, a server communication entity is associated with different internal components and external components. In accordance with an embodiment of the present invention, the server communication entity includes a CPM PF device 106. Additionally, although the server communication entity may include many external and internal components, for the purpose of this description, only few components are illustrated. For example, the server communication entity illustrated in FIG. 5 includes a processor 504, a transceiver 502, a memory 506, a server storage unit, a communication interface, a display, an input device, and a cursor control, all connected through a common bus.

The server communication entity includes a bus for communicating information, and a processor coupled with the bus for processing information. The server communication entity also includes a memory 506, for example, a random access memory (RAM) coupled to the bus for storing information required by the processor. The memory can be used for storing temporary or permanent information required by the processor. Additionally, the server communication entity may also include a Read Only Memory (ROM) coupled to the bus for storing static information required by the processor. A server storage unit, for example a magnetic disk, hard disk or optical disk, can be provided and coupled to bus for storing information.

The server communication entity can be coupled via the bus to a display, such as a Cathode Ray Tube (CRT) or Liquid Crystal Display (LCD), for displaying information. An input device, including various keys, is coupled to the bus for communicating information to the processor. A cursor control, for example, a mouse, a trackball, a joystick, or cursor direction keys for communicating information to the processor and for controlling cursor movement on the display can also be present.

The information can be read into the memory from a machine-readable medium, for example, the server storage unit. Alternatively, hard-wired circuitry can be used in place of or in combination with software instructions to implement various embodiments. The term machine-readable medium can be defined as a medium providing data to a machine to enable the machine to perform a specific function. The machine-readable medium can be a storage media. Storage media can include non-volatile media and volatile media. The server storage unit can be a non-volatile media.

The memory can be a volatile media. All such media is tangible to enable the instructions carried by the media to be detected by a physical mechanism that reads the instructions into the machine. Examples of the machine readable medium includes, but are not limited to, a floppy disk, a flexible disk, hard disk, magnetic tape, a CD-ROM, optical disk, punch cards, paper tape, a RAM, a PROM, EPROM, and a FLASH-EPROM.

The server communication entity also includes a communication interface coupled to the bus for enabling data communication. Examples of the communication interface include, but are not limited to, an Integrated Services Digital Network (ISDN) card, a modem, a Local Area Network (LAN) card, an infrared port, a Bluetooth® port, a zigbee port, and a wireless port.

In accordance with an embodiment of the present invention, the transceiver 502 initially receives a CPM message that is to be delivered to a CPM client. After receiving the CPM message the processor 504 identifies user preferences that are preset by the CPM client. For example, the user preference is associated with storing of the CPM message in a message storage server. The transceiver 502 sends the CPM message to the CPM client through a SIP channel.

In accordance with an embodiment of the present invention, the transceiver 502 does not send the CPM message to the CPM client immediately after receiving, but stores the CPM message in a message storage server and then sends it to the CPM client along with the UID. The UID is used to avoid duplicate transmission of the IMAP message stored in the message storage server.

The processor 504 converts the CPM message into an IMAP message when the user preference associated with the storing of the CPM message is enabled. For example, the processor 504 converts the CPM message to the IMAP message based on the contribution ID, the Conversation ID and the In-reply-to ID. Thereafter, the processor 504 sends the IMAP message for storing in the message storage server. The IMAP message is stored in a message storage that is associated internally or externally with the server communication entity, for example, the memory 506.

Thereafter, the transceiver 502 receives a UID associated with the IMAP message stored in the message storage server. Further, the transceiver sends information associated with the CPM message and the UID associated with the IMAP message to the CPM client 108.

In accordance with an embodiment of the present invention, a local storage associated with the CPM client and the message storage server is synchronized based on the contribution ID, the conversation ID and the In-reply-to ID.

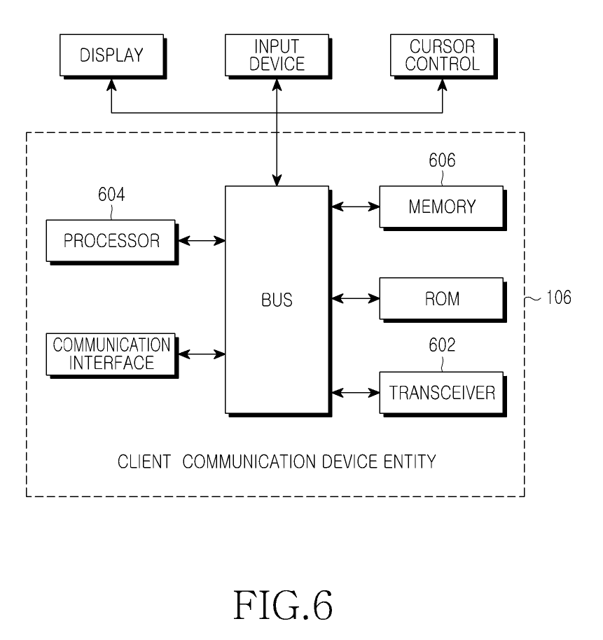

FIG. 6 illustrates a client communication device entity, in accordance with an embodiment of the present invention.

Referring to FIG. 6, the client communication device entity includes a CPM client 108. Although the client communication device entity may include many external and internal components, for the purpose of this description, only few components are illustrated. For example, the server communication entity illustrated in FIG. 6 includes a processor 604, a transceiver 602, a memory 606, a Read Only Memory (ROM), a communication interface, a display, an input device, and a cursor control, all connected through a common bus.

The functions performed by each component are similar to the functions of the components described with reference to FIG. 5. However, the functions performed by the transceiver 602 and the processor 604 are different and will be explained below.

In accordance with an embodiment of the present invention, the transceiver 602 receives a CPM message from a server communication entity. The processor 604 then convert the CPM message to an IMAP message and sends the converted message for storing in local storage. The local storage, e.g., a memory 606, may be externally or internally associated with the client communication device entity. The transceiver 602 then receives a UID associated with the CPM message from a CPM PF. The transceiver 602 also receives additional information associated with the CPM message, for example, a contribution ID, a conversation ID, etc.

The processor 604 updates the messages stored in the local storage with the received UID and the additional information associated with the message. Thereafter, a synchronization process is performed between the local storage and the server storage. The processor 604 synchronizes at least one message stored in the local storage and the message storage server based on the UID when a request for synchronizing is received from a user, wherein the synchronization is not performed on a message that is associated with the UID.

The transceiver 602 directly receives the CPM message and the UID information. Thereafter, the processor 604 converts the CPM message to the IMAP message and updates the local storage with the IMAP message and the UID information. Synchronization is performed between the local storage and the server storage unit so as to synchronize the messages stored in both the messages.

As described above, the various embodiments of the present invention provide methods and systems for managing the storage of CPM messages in a communication network. The methods propose an efficient mechanism for handling a CPM network to deliver CPM messages only once, avoiding duplicate messages on the device. Accordingly, an efficient mechanism is provided for handling the CPM network to deliver, e.g., pager-mode messages, only once and manage memory space efficiently.

The present invention also keeps the message status up to date on the message storage server for the messages delivered. This increases the efficiency of the communication network as the method avoids unnecessary processing of the CPM messages. Further, the turnaround time for storing the CPM messages is also reduced as the CPM messages get directly stored and are not fetched later from the server.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for managing storing of Converged Internet Protocol Messaging (CPM) messages by a server in a communication network, the method comprising:
receiving, by the server, a CPM message that is to be delivered to a CPM client;
identifying a user preference associated with storing of the CPM message in a message storage server;
sending the CPM message to the CPM client through a Session Initiation Protocol (SIP) channel;
converting the CPM message into an Internet Message Access Protocol (IMAP) message, when the user preference associated with the storing of the CPM message is enabled;
storing the IMAP message in the message storage server;
matching a Unique IDentifier (UID) associated with the IMAP message stored in the message storage server; and
sending information associated with the CPM message and the UID associated with the IMAP message to the CPM client.

2. The method of claim 1, further comprising receiving the UID from the message storage server.

3. The method of claim 1, wherein sending the CPM message to the CPM client comprises notifying the CPM client to convert the CPM message in to an IMAP message and store the IMAP message in a local storage associated with the CPM client.

4. The method of claim 3, further comprising synchronizing at least one message stored in the local storage associated with the CPM client and the message storage server,
wherein synchronizing is not performed on a message that is associated with a received UID.

5. The method of claim 1, wherein sending the information associated with the CPM message and the UID associated with the CPM message to the CPM client comprises notifying the CPM client to associate the UID with the corresponding CPM message in a local storage.

6. The method of claim 1, wherein sending the information associated with the CPM message comprises including a conversation ID and a contribution ID associated with the CPM message with the UID associated with the CPM message.

7. The method of claim 5, wherein sending the information associated with the CPM message further comprises notifying the CPM client to associate the conversation ID, the contribution ID, and the UID with a corresponding CPM message in a local storage.

8. The method of claim 1, wherein the server is a CPM network defined by Open Mobile Alliance (OMA) standard.

9. The method of claim 1, wherein the CPM message includes at least one of a pager mode message, a large mode message, a session based message, and a file transfer message.

10. A method for managing storing of Converged Internet Protocol Messaging (CPM) messages by a server in a communication network, the method comprising:
receiving, by the server, a CPM message that is to be delivered to a CPM client;
identifying a user preference associated with storing of the CPM message in a message storage server;
converting the CPM message into an Internet Message Access Protocol (IMAP) message, when the user preference associated with the storing of the CPM message is enabled;
storing the IMAP message in the message storage server;
matching a Unique IDentifier (UM) associated with the IMAP message stored in the message storage server; and
sending information associated with the CPM message and the UID associated with the IMAP message to the CPM client.

11. The method of claim 10, further comprising receiving the UID from the message storage server.

12. The method of claim 10, wherein sending the information associated with the CPM message and the UID associated with the IMAP message comprises notifying the CPM client to convert the CPM message in to an IMAP message and store the IMAP message in a local storage associated with the CPM client.

13. The method of claim 11, further comprising synchronizing at least one message stored in the local storage associated with the CPM client and the message storage server,
wherein synchronization is not performed for a message that is associated with a received UID.

14. The method of claim 10, wherein sending the information associated with the CPM message and the UID associated with the CPM message to the CPM client comprises notifying the CPM client to associate the UID with a corresponding CPM message in a local storage.

15. The method of claim 10, wherein sending the information associated with the CPM message comprises including a conversation ID and a contribution ID associated with the CPM message with the UID associated with the CPM message.

16. The method of claim 15, wherein sending the information associated with the CPM message further comprises notifying the CPM client to associate the conversation ID, the contribution ID, and the UID with a corresponding CPM message in a local storage.

17. The method of claim 10, wherein the CPM message includes at least one of a pager mode message, a large mode message, a session based message, and a file transfer message.

18. A method for managing storing of Converged Internet Protocol Messaging (CPM) messages by a server in a communication network, the method comprising:
receiving, by the server, a CPM message that is to be delivered to a CPM client;
sending the CPM message to the CPM client using a Session Initiation Protocol (SIP) channel;
converting the CPM message to an Internet Message Access Protocol (IMAP) message, based on a Contribution ID, a Conversation ID, and an In-reply ID;
sending the MAP to a message storage server for storing; and
receiving a Unique IDentifier (UID) from the message storage server.

19. The method of claim 18, further comprising synchronizing at least one message stored in a local storage associated with the CPM client and the message storage server based on the contribution ID, the Conversation ID, and the In-reply to ID.

20. The method of claim 18, wherein the synchronization is not performed on a message that is associated with a received UID.

21. The method of claim 18, wherein the CPM message includes at least one of a pager mode message, a large mode message, a session based message, and a file transfer message.

22. A server communication entity comprising:
a transceiver for:
receiving a Converged Internet Protocol Messaging (CPM) message that is to be delivered to a CPM client,
sending the CPM message to the CPM client through a Session Initiation Protocol (SIP) channel, and
sending information associated with the CPM message and the UID associated with the IMAP message to the CPM client;
a processor for:
matching a Unique IDentifier (UID) associated with an Internet Message Access Protocol (IMAP) message stored in a memory,
identifying a user preference associated with the storing of the CPM message, and
converting the CPM message into the IMAP message, when the user preference associated with the storing of the CPM message is enabled; and
the memory for storing the IMAP message, when the user preference associated with storing of the CPM message is enabled.

23. The server communication entity of claim 22, wherein the UID is used to avoid duplicate transmission of the IMAP message stored in the message storage server when a request for synchronizing is received from the CPM client.

24. The server communication entity of claim 22, wherein the IMAP message is stored in the memory that is associated internally or externally with the server communication entity.

25. A method for managing storing of Converged Internet Protocol Messaging (CPM) messages by a client communication device in a communication network, the method comprising:
receiving, by the client device, a CPM message and a Unique IDentifier (UID) associated with an Internet Message Access Protocol (IMAP) message stored in a message storage server;
converting the CPM message into a message format for storing in the message storage server; and
associating the CPM message with the UID and storing the CPM message.

26. The method of claim 25, wherein the CPM message is stored in a local storage associated with the client communication device.

27. The method of claim 26, further comprising synchronizing at least one message stored in the local storage and the message storage server based on the UID when a request for synchronizing is received from a user, wherein the synchronization is not performed on a message that is associated with the UID.

28. The method of claim 25, wherein converting step comprising converting the CPM message into an Internet Message Access Protocol (IMAP) message.

29. A client communication device comprising:
a transceiver for receiving a Converged Internet Protocol Messaging (CPM) message and a Unique IDentifier (UID) associated with an Internet Message Access Protocol (IMAP) message stored in a message storage server; and
a processor for converting the CPM message into a message format for storing in the message storage server, and associating the CPM message with the UID and storing the CPM message.

30. The client communication device of claim 29, wherein processor stores the CPM message in a local storage associated with the client communication device.

31. The client communication device of claim 29, wherein processor synchronizes at least one message stored in the local storage and the message storage server based on the UID when a request for synchronizing is received from a user, wherein the synchronization is not performed on a message that is associated with the UID.

32. The client communication device of claim 29, wherein processor converts the CPM message into an Internet Message Access Protocol (IMAP) message.
